(19) United States
(12) Patent Application Publication
(10) Pub. No.: US 2003/0002660 A1
(43) Pub. Date: Jan. 2, 2003

(54) Network interface device and high speed delivery method therefor

(76) Inventors: James Albanese, Palatine, IL (US); Sean Iwasaki, Chicago, IL (US); William Rodey, Countryside, IL (US)

Correspondence Address: PATULA & ASSOCIATES P.C., 14th Floor, 116 South Michigan Avenue, Chicago, IL, 60603, US

(21) Appl. No.: 09/881,083

(22) Filed: Jun. 13, 2001

(51) Int. Cl. H04M 1/00; H04M 9/00

(52) U.S. Cl. 379/413.02; 379/399.01

(57) ABSTRACT

A method and device for delivering high speed telecommunications services in existing network interface devices comprises a network interface unit block or module, with an associated removable customer access module, which can be mounted in an existing slot cavity of an existing network interface device to terminate DSL or T1 service, or “pass-thru” T1 service, so as to provide both traditional residential service and high-speed digital service to a customer.

The present invention relates generally to telecommunications equipment and, in particular, to a network interface device (“NID”), and high speed delivery method, used to provide both traditional residential service (i.e., POTS service) and high speed digital service to a customer. Specifically, the present invention is comprised of a network interface unit (“NIU”) module, with an associated removable customer access module, which can be mounted in the existing slot cavities of an existing NID to terminate DSL or T1 service, or “pass-thru” T1 service.

### BACKGROUND OF THE INVENTION

Digital Subscriber Line (“DSL”) is a standardized technology which offers significant improvements in high-speed digital service over existing copper facilities. These improvements provide an increase in the speed of the digital services, decrease in cable pair utilization, increase in noise immunity, and a decrease in service installation time. DSL is represented by a number of variations (generally designated by the acronym “xDSL”) to accommodate specific applications. Each DSL variant is unique with respect to performance, applications and cable pair utilization.

Integrated Services Digital Network (“ISDN”) and Asymmetric Digital Subscriber Line (“ADSL”) are DSL technology generally used as a high-speed digital transmission transport for residential service. For residential service, a NID is installed on or near the customer's house to establish a demarcation point. The demarcation point establishes the telephone service responsibility between the Network Service Provider and the customer. The NID passes-thru the ISDN and ADSL service to the customer.

There are two methods for delivering high-speed services, namely, termination and pass-thru. High speed services involving DSL technology are typically terminated within the NID, while T1 technology can be either terminated or passed-thru. Terminating high speed services involves the conversion of the DSL or T1 technology into a digital signal format in the transmission path. This digital signal format is then converted into another technology to interface the customer's equipment. Pass-thru high speed service does not perform DSL or T1 technology conversion in the transmission path.

The NID is a plastic mechanical enclosure designed for outdoor environments for the purpose of terminating the Network Service Provider's copper facilities and allowing the customer access to those facilities (see FIG. 1 (prior art)). The NID 1 has two compartments, a customer compartment 2 and a network access compartment 3. Each compartment is accessed through a series of hinged doors 4a and 4b, whereas the customer can only access their compartment, and the Network Service Provider can access both compartments.

The NID is typically designed to terminate the Network Service Provider's copper facilities and provide a plurality of two-wire telephone services (i.e., POTS services) to the customer. Thus, the network access compartment has a plurality of single slot cavities 5 for receiving components to provide such telephone services. One or more of the cavities in the network access compartment receives a transient protection device 6 that protects the NID. The transient protection device has screw terminals that interface to the Network Service Provider's copper facilities. One or more of the corresponding cavities in the customer access compartment receives a removable customer access module 7 having wires for connecting to the transient protector, and an interface, typically a RJ11 modular jack, for connecting the customer's telephone or other communication equipment.

Other components which can be used in these cavities include an ADSL Splitter, an Analog Line Conditioner, or a Test Circuitry. Each of these components are described below.

An ADSL Splitter is a device that separates ADSL technology from analog voice carried on telephone wire. The ADSL Splitter does not terminate DSL services, but instead separates the POTS and ADSL service from the copper facilities. The ADSL Splitter passes-thru the ADSL service to the customer's equipment for ADSL service termination. The ADSL Splitter is mainly comprised of passive circuitry and therefore contains a minimal amount of electronic circuitry. The ADSL Splitter is used in conjunction with the existing removable customer access module. Such a device is disclosed in U.S. Pat. No. 6,026,160, issued to Staber et al. on Feb. 15, 2000, the disclosure of which is herein incorporated by reference.

An Analog Line Conditioner is a device that equalizes and conditions the analog voice signal to increase the performance of analog modems (e.g. V.32 type modems). The Analog Line Conditioner does not terminate DSL services. The Analog Line Conditioner equalizes and conditions the analog voice signal and then passes-thru the optimized analog voice signal to the customer. The Analog Line Conditioner is a device that is comprised of active and passive circuitry. The Analog Line Conditioner is used in conjunction with the existing removable customer access module. As with the ADSL Splitter, the Analog Line Conditioner is used in conjunction with ADSL service.

Test Circuitry or Over-Voltage Protection components are simply modified removable customer access modules which integrate the test circuitry or over-voltage protection by placing the circuitry underneath the RJ11 and terminal screws of the removable customer access module. This circuitry does not assist or provide functionality for the termination or pass-thru of signals. Test circuitry provides the Network Service Provider the ability to test the copper facilities. Over-voltage protection provides the protection of the copper facilities from the customer. Such a device is disclosed in U.S. Pat. No. 6,011,831, issued to Nieves et al. on Jan. 4, 2000, and U.S. Pat. No. 5,367,569 issued to Roach et al. on Nov. 22, 1994, the disclosures of which are herein incorporated by reference.

Other DSL variants such as High-Speed Digital Subscriber Line using two wire pairs (“HDSL”), High-Speed Digital Subscriber Line2 (“HDSL2”), High-Speed Digital Subscriber Line2 using two wire pairs (“HDSL4”) (generally “HDSLx”), ISDN Digital Subscriber Line (“IDSL”), Symmetric High-Speed Digital Subscriber Line (“G.shdsl”), and Very High-Speed Digital Subvscriber Line (“VDSL”), as well as T1 service, are used for high speed digital service. T1 service is a legacy technology which provides high-speed symmetrical digital transmission over two wire pairs.

For high-speed digital service, a NIU is typically installed at the customer's facility to establish the demarcation point and to provide the Network Service Provider maintenance and testing capabilities on the high speed service. The NIU is a printed circuit board that is populated with various electronic components to provide the test and maintenance capabilities, as well as DSL or T1 termination, or T1 pass-thru. The NIU is installed in a mechanical mounting which provides the necessary connectors to interface and terminate the Network Service Provider's copper facilities and allow customer access to the high-speed digitial service being carried by those facilities.

To provide high speed service along with traditional residential service (i.e., POTS service) to the customer, both an NID and an NIU are used. There have been three known approaches to accomplish the same.

The first known approach involves the installation of a traditional NIU (i.e., plug-in card mechanics) a short distance away from the NID, approximately one hundred to two hundred feet. In this approach, the NIU is typically installed within the customer's residence. There are numerous disadvantages to this approach. The material cost involved with this approach includes the cost of the NIU and the NIU mechanical mounting. The installation requires a technician to install the NIU mounting at the customer's facility, requiring coordination and scheduling, which often is a very time consuming and iterative process. Further, the installation requires the technician to locate an appropriate place to install the NIU mounting and then route wire from the NID to the NIU. Additionally, the installation of the NIU mounting at the customer facility extends the demarcation point. The Network Service Provider would then be responsible for service to the NIU.

The second approach to providing both residential service and high speed service to a customer is to replace the existing NID cover or lid with another cover or lid that supports an encapsulated, traditional NIU. This replacement lid is designed with an extended cavity to support the encapsulated NIU and associated mechanical support brackets. The replacement lid is visually similar to the existing NID cover with the exception of an increase in depth, with the encapsulated NIU filling substantially the entire increased area inside the replacement lid. There are numerous disadvantages to this approach as well. The material cost involved with this approach includes the cost of the replacement NID cover and an encapsulated NIU. The installation requires a technician to remove the existing NID cover and replace it with the integrated NID cover. Since an NID base and cover is designed to provide a hermetic seal upon closure and under an outdoor weather environment, the removal of the NID cover may damage the hermetic seal with the existing NID base, e.g., by potential damage to the existing NID's hinges and lid-to-base fitting. Additionally, the removal of the NID cover can be difficult, as proper tools and often significant physical force are required. Further, wiring of the encapsulated NIU in the replacement lid to the existing NID base is required.

The third approach is to replace the entire NID with another NID that is designed to support a traditional NIU. This new NID is functionally similar to the replacement NID cover, except that this new NID includes a cavity in the cover that supports an NIU and associated mechanical brackets. As before, there are numerous disadvantages to this approach. The material cost involved with this approach includes the cost of the new NID and the NIU. The installation requires a technician to remove the entire NID and replace it with the new NID that accommodates an NIU. The removal of the entire NID would involve significant time and effort as well as customer phone service interruption.

The present invention, however, overcomes the problems and disadvantages of these prior art approaches to providing both traditional residential and high speed digital service to a customer. The present invention provides for an improved, cost-effective, time saving, and user friendly method and device for delivering high speed digital services in an existing NID without the need to modify the NID in any manner.

### BRIEF SUMMARY OF THE INVENTION

The present invention is a method and device for delivering high speed digital services in existing NIDs. The present invention comprises a NIU block or module with an associated removable customer access module, which can be mounted in existing cavities of an existing NID to terminate DSL or T1 service, or “pass-thru” T1 service.

Accordingly, it is the principle object of the present invention to provide a method and device for delivering high speed digital services in existing NIDs.

It is a further object of the present invention to provide a method and device for interfacing DSL services received from the Network Service Provider at a NID.

It is another object of the present invention to provide a user friendly, cost-effective, and time efficient method and device for the providing an NIU in an existing NID.

It is also an object of the invention to provide a NIU block or module for use within the slot cavities of an existing NID.

It is an additional object of the present invention to encompass the following DSL services: HDSLx, G.shdsl, ADSL, VDSL and T1 technologies; as well as to encompass the delivery of different services to the customer, e.g., Home Phoneline Networking Alliance (“HPNA”), Ethernet, Wireless (Bluetooth, IEEE 802.11b, etc.), T1.

It is yet another object of the invention to encompass different NIDs from different manufacturers and mechanical form factors.

Numerous other advantages and features of the invention will become readily apparent from the detailed description of the preferred embodiment of the invention, from the claims and from the accompanying drawings in which like numerals are employed to designate like parts throughout the same.

### BRIEF DESCRIPTION OF THE DRAWINGS

A fuller understanding of the foregoing may be had by reference to the accompanying drawings wherein:

FIG. 1 is a perspective view of a prior art NID.

FIG. 2 is a schematic block diagram of the present invention.

### DETAILED DESCRIPTION OF THE PREFERRED EMBODIMENT OF THE PRESENT INVENTION

While the invention is susceptible of embodiment in many different forms, there is shown in the drawings and will be described herein in detail a preferred embodiment of the present invention. It should be understood, however, that the present disclosure is to be considered an exemplification of the principles of the invention and is not intended to limit the spirit and scope of the invention and/or claims of the embodiment illustrated.

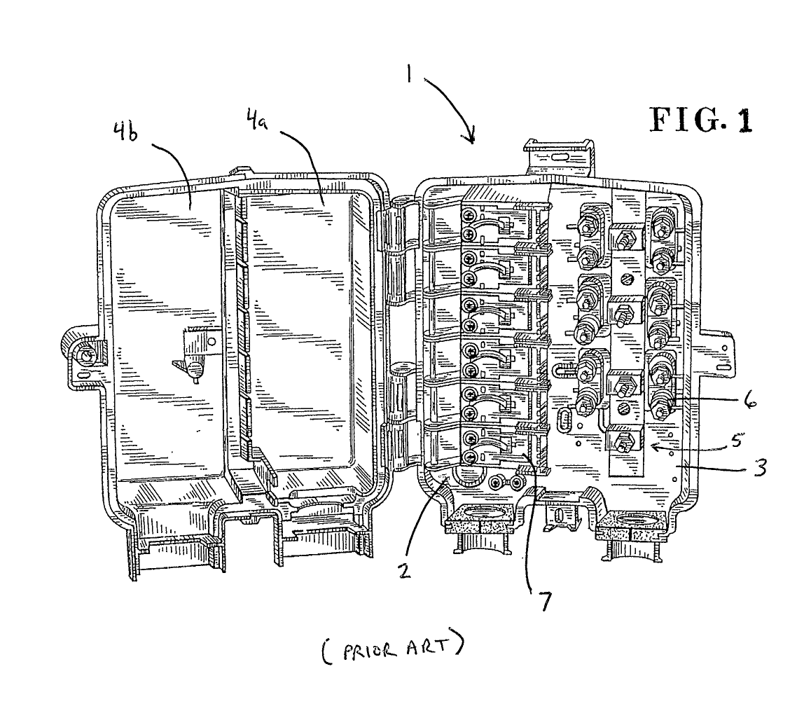

As described above, FIG. 1 illustrates a prior art NID 1 having two compartments, a customer access compartment 2 and a network access compartment 3. Each compartment is accessed through a series of hinged doors 4a and 4b, respectively, whereas the customer can only access their compartment, and the Network Service Provider can access both compartments.

The network access compartment 3 has four single slot cavities 5 for receiving components. As shown, three of the four cavities 5 have a transient protection device 6 therein. The fourth (lowermost) cavity is shown empty. As further shown, the customer access compartment 2 has a total of six slots, each of which are shown to have a removable customer access module therein.

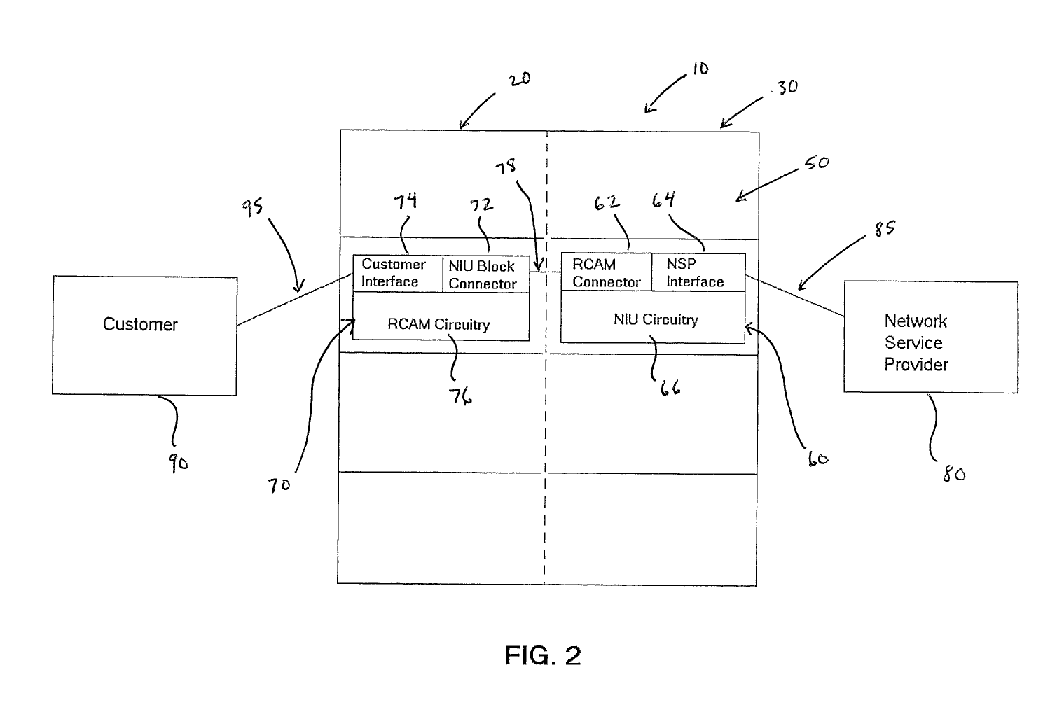

Referring now to FIG. 2, the present invention is shown via a schematic block diagram, wherein a NID 10 is shown to have a customer access compartment 20 (left side), and a network access compartment 30 (right side). For ease of illustration, each compartment is shown to have four single slot cavities 50.

Installed within the confines of the slot cavities in the NID's network access compartment is a NIU block or module 60. NIU block 60 comprises a remote customer access module (“RCAM”) connector 62, a Network Service Provider (“NSP”) interface 64, and the NIU circuitry 66. The NIU block 60 interfaces with the Network Service Provider 80 through the Network Service Provider's copper facility 85, or any other suitable connection. The NIU block 60 terminates the copper facility, allowing the NIU block 60 to offer the customer different service types. The NIU block 60 is comprised of active (electronic) and passive (non-electronic) components. The NIU block is specifically designed to use G.shdsl, HDSL2, HDSL4, ADSL, VDSL or T1 technologies to interface the Network Service Provider's copper facilities.

Installed within the confines of a corresponding single slot cavity in the NID's customer access compartment is a modified remote customer access module (“RCAM”) 70. RCAM 70 comprises a NIU block connector 72, a Customer interface 74, and the modified RCAM circuitry 76. The RCAM circuitry 76 is modified such that the RCAM 70 can operate to provide to the customer the appropriate DSL or T1 service terminated by the NIU block 60. The NIU block connector 72 operatively connects the RCAM 70 with the NIU block 60 at RCAM connector 62 via electrical connector 78, or any other suitable connector. The RCAM 70 further interfaces, via Customer interface 74, with the Customer 90 through the Customer's telecommunications equipment (line) 95, or any other suitable connection.

The RCAM 70 provides the appropriate physical connection (interface 74) to the customer according to the service type. The following chart is illustrative:

| NETWORK | CUSTOMER | CUSTOMER |
|---|---|---|
| SERVICE | SERVICE | PHYSICAL |
| TERMINATION | DELIVERY | INTERFACE |
| HDSL, HDSL2, | T1, Ethernet, HPNA, | RJ48, RJ11 or |
| HDSL4, ADSL, | Wireless | Terminal Screws |
| VDSL, G.shdsl, T1 | | |

Depending upon the service delivered to the customer, the removable customer access module can be comprised of both active and passive components. The RCAM 70 may have circuitry that provides media conversion, such as an Ethernet electrical interface. The RCAM 70 may also have components that are part of the circuitry that provides signal pass-thru or termination.

The novel and unobvious method and device as described above allows for the high speed delivery of both residential and leased-line service in existing NIDs. Such a method and apparatus provides the lowest material cost and the simplest installation as compared to the three known approaches described above. Additionally, the same demarcation point will be maintained, as is desired.

It is to be understood that the embodiment herein described is merely illustrative of the principles of the present invention. Various modifications may be made by those skilled in the art without departing from the spirit or scope from the claims which follow.

What is claimed is:

1. A network interface device comprising:
a housing defining a network access compartment and a customer access compartment, each having slot cavities;
a network interface unit module removably mounted in said housing in at least one of said slot cavities of said network access compartment; and
a corresponding removable customer access module mounted in said housing in at least one of said slot cavities of said customer access compartment.

2. The device of claim 1, wherein said network interface unit module includes network interface unit circuitry, a network service provider interface, and a removable customer access module interface.

3. The device of claim 2, wherein said removable customer access module includes removable customer access module circuitry compatible with said network interface unit circuitry, a network interface module connector, and a customer equipment interface.

4. The device of claim 1, wherein said network interface unit module terminates network services.

5. The device of claim 4, wherein said network services which are terminated are HDSL, HDSL2, HDSL4, G.shdsl or T1 service.

6. The device of claim 1, wherein said network interface unit module and said removable customer access module cooperate to deliver high speed telecommunications services.

7. The device of claim 5, wherein said high speed telecommunications services which are delivered are Ethernet, Wireless, Home Phoneline Networking Alliance, or T1 service.

8. The device of claim 3, wherein said customer equipment interface is an RJ48 or RJ11 interface or terminal screws.

9. A method of delivering high speed telecommunications services in existing network interface devices having a housing defining a network access compartment and a customer access compartment, each having a plurality of slot cavities, said method comprising the steps of:
removably mounting a network interface unit module in said housing in at least one of said plurality of slot cavities of said network access compartment;
removably mounting a corresponding removable customer access module mounted in said housing in at least one of said plurality of single slot cavities of said customer access compartment;
operatively connecting said network interface unit module to a network service provider's facilities;
operatively connecting said network interface unit module to said corresponding removable customer access module; and
operatively connecting said removable customer access module to a customer's telecommunication equipment.

10. The method of claim 9, further comprising the step of terminating in said network interface unit module a signal received from said network service provider's facility.

11. The method of claim 10, wherein said signal which is terminated is an HDSL, HDSL2, HDSL4, ADSL, VDSL, G.shdsl or T1 service.

12. The method of claim 10, further comprising the step of delivering via said removable customer access module said high speed telecommunications services.

13. The device of claim 12, wherein said high speed telecommunications services which are delivered are Ethernet, Wireless, Home Phoneline Networking Alliance, or T1 service.

14. A network interface unit for installation in a network interface device having a housing defining a network access compartment and a customer access compartment, each having a plurality of slot cavities, said network interface unit comprising:
a network interface unit module adapted to insert into the confines of at least one of said slot cavities of said network access compartment, said module comprising network interface unit circuitry, a first interface for connecting said network interface unit module to a network service provider's facility, and a second interface for connecting said network interface unit module to a removable customer access module.

15. A method of integrating a network interface unit in an existing network interface device having a housing defining a network access compartment and a customer access compartment, each having a plurality of slot cavities, said method comprising the steps of:
providing a network interface unit module adapted to insert into the confines of at least one of said slot cavities of said network access compartment such that high speed telecommunications services can be terminated and delivered without having to replace or modify the existing network interface device.
